(19) United States
(12) Patent Application Publication
(10) Pub. No.: US 2022/0237198 A1
(43) Pub. Date: Jul. 28, 2022

(54) SYSTEM AND METHOD FOR CREATING AND MANAGING ACTIONABLE DATA

(71) Applicant: Element Standard, Inc., Orlando, FL (US)

(72) Inventors: Jaron Luttich, Orlando, FL (US); Ryan HUDSON, Orlando, FL (US)

(21) Appl. No.: 17/581,511

(22) Filed: Jan. 21, 2022

Related U.S. Application Data
(60) Provisional application No. 63/140,366, filed on Jan. 22, 2021.

(51) Int. Cl. G06F 16/2457; G06F 16/93

(52) U.S. Cl. CPC G06F 16/24578; G06F 16/93

(57) ABSTRACT

The invention encompasses a computer system that identifies and prioritizes a structure and design solution that provides a needed structure to the legal and business industry in three critical areas: timekeeping and billing, tracking and case management, and training. The computer system includes a communication network linked to one or more of the sources and a computer server in communication with the communication network.

### CROSS-REFERENCE TO RELATED APPLICATIONS

This application claims the benefit of U.S. provisional patent application No. 63/140,366, which was filed on Jan. 22, 2021, and is incorporated herein by reference in its entirety.

### FIELD OF THE INVENTION

The invention encompasses a system and method that identifies and prioritizes a structure and design solution that provides a needed structure to various industries including the legal and business industry, for example, timekeeping and billing, tracking and case management, and training. The system and method includes a communication network linked to one or more of the sources and a computer server in communication with the communication network. The server is configured to receive electronic documents from the sources via the communication network. The computer server has memory and a processor, the memory including processor executable instructions stored in the memory and executable by the processor. The instructions comprise data collection instructions, topic modeling instructions including instructions for weighing and instructions for indicating a distribution for identified issues within each of the retrieved documents, issue assignment instructions, instructions for determining, and instructions for management.

### BACKGROUND OF THE INVENTION

Collections of data are becoming commonplace in the legal industry. However, these large stores of data are useless without the employment of effective techniques for uncovering meaningful, actionable insights out of the multitude of available information.

As trends intensify and issues become more volatile, the time that managers have to react to these issues diminishes, and their available options dwindle quickly. There is a need for systems and methods which address this problem to maximize control while limiting losses and missed opportunities.

If the process of sifting through large amounts of data to select and prioritize issues for each report was done solely by hand, it would 1) take an inordinate amount of time, 2) have a high potential for error, and 3) undoubtedly introduce some measure of subjectivity.

As these drawbacks are quite significant, the instant invention provided a solution which will perform the task of issue discovery and prioritization in a consistent, repeatable fashion. The solution further permits voluminous data from multiple litigations and among multiple counsel to be consolidated without introducing error in the issue discovery and prioritization process.

### SUMMARY OF THE INVENTION

In its broadest embodiments, the invention encompasses a system and method for achieving the following: for distributed content tracking and management, billing tracking and management and training. In various embodiments, the invention encompasses a data system that includes a content engine for managing the storage of file content, a content signature generator that generates a unique content signature for a file processed by the content engine, a content signature comparator that compares content signatures and a content repository that stores content signatures, a content financial manager that allow ease of billing and tracking time, and a content allocation manager that groups data and allows for inclusion in a training system. Methods are provided for the efficient management of files using content signatures that take advantage of file properties. Content signature application modules and registries exist within information sources and centralized servers to support the content signature methods.

In various embodiments, the invention encompasses a system and method for managing data for designated projects, especially those requiring time-sensitive data management. It is further an embodiment of the invention to provide a system and a method managing the costs of the designated projects including payroll management, the and document identification and stratification, and training.

In various embodiments, the invention encompasses a system and a method for managing industry representations related to personnel, customers, projects, equipment and to other subjects. It is further an aspect of the present invention, to provide a system and a method for comprehensive management of documents of various kinds.

In various embodiments, the invention encompasses a system and a method to facilitate secure sharing of documents between various entities within an organization. It is further an aspect of the present invention to provide a system and a method for verification of various documents.

In various embodiments, the invention encompasses a computer-assisted system and a method is provided for managing data, time, billing, and documents. A storage system stores industry representations and lists of data related to various topics and projects. Based on this analysis, a processor then selects a data from the list. The processor may select the data for various viewings and manipulations.

In various embodiments, the invention encompasses a computer program product and a computer system adapted to manage documents has a processor, a memory with instructions adapted to enable the system to perform the following steps: storing a list of data related to a project, relationally linking the data with one or more subheadings, analyzing each data set based on data related to a project, and selecting one or more data foes based on this analysis.

Accordingly, in various embodiments, the invention encompasses a method for managing documents is provided. In the method, a plurality of documents and a list of topics are stored and some of the documents are sorted then linked to one or more topics. The method further analyzes a topic based on the documents relationally linked to the topic.

In various embodiments, the invention encompasses a system and a method for uploading, tracking, and prioritizing documents. In this embodiment, a topic and a data set is selected. The data or document is uploaded or created, and the user inputs information for the uploaded data or document to organize the information under a subtopic.

In a preferred embodiment, the invention includes a system and method for tracking data based on client; matter; project; event; task; document, budgeting, project management, assessment; and various alternative enhancements. In certain embodiments, Client, Project, and/or Activity data may be provided. Alternatively, the present invention preferably comprises: Client; Matter; and Event. The invention may further comprise related information, data; and/or analysis, such as: communications; documents; forms; budget and/or cost information; project management; risk management; and other applications or information. The system of the present invention may be adapted to cooperate with other shared or linked data sources.

The invention may be embodied in various forms, including, without limitation: data, software applications, network, data processing system, method, and various alternative forms. In a preferred embodiment, the invention comprises data relating to a professional services project. The data of the invention may be in a format that is other than exclusively proprietary, other than proprietary, or other than substantially proprietary. Further, the data may be in a format that is: substantially portable; portable; substantially application-independent; or application-independent. The data may be: docketing; calendaring; word processing; document management; accounting; time and billing; or any other data of a type used in a professional services practice.

Alternatively, the invention may be embodied in a software application, for use in conjunction with a professional services project, the data cooperating with data storage means, the data being in machine readable format, comprising data in substantially portable format.

In another alternative embodiment, the invention comprises: a data processing system for managing data related to a professional services project, comprising: computer for processing the data; a software application cooperating with said computer; and data storage means cooperating with said computer for storing data; the data cooperating with said software application; the data in a substantially portable format.

In a further embodiment, the invention comprises a project management system for a professional services project, comprising: computer network; data processing cooperating with said network; one or more distributed applications, cooperating with said data processing; data storage, cooperating with said one or more distributed application, for storing data; said data being substantially portable between said one or more distributed applications. Alternatively, the invention comprises: a computer network for managing a professional services practice, comprising: a network; data processing; one or more distributed applications; data cooperating with said one or more distributed applications; data storage for storing said data from said one or more distributed applications; and project management database cooperating with said one or more distributed applications for facilitating the communication of said data from said one or more distributed applications.

In yet another embodiment, the invention comprises an improvement on a computer network for managing a professional services practice, comprising a computer network, data processing, one or more distributed applications, data cooperating with said one or more distributed applications, and data storage for storing said data from said one or more distributed applications, the improvement comprising a project management database cooperating with said one or more distributed applications for facilitating the transfer of said data from said one or more distributed applications. Alternatively, the improvement may comprise, in a computer network for managing a professional services practice, comprising a computer network, data processing, one or more distributed applications, data cooperating with said one or more distributed applications, and data storage for storing said data from said one or more distributed applications, the improvement comprising: a case management data base; said case management database communicating with said one or more applications; said case management database being adapted to receive data from said one or more applications; said data being substantially portable data.

Alternatively, the invention may be embodied in a user interface for a network used in a professional services practice, comprising: first substantially distributed application; second substantially distributed application; said first distributed application being adapted to communicate with said second distributed application; data storage cooperating with one or more of said first or second distributed applications for storing data used in the professional services practice; a user interface capable of accessing said data; and said user interface adapted to cooperate with one or more of said first or second distributed applications and said data storage. In another embodiment, a user interface may further comprise categorization by client; matter; and/or project. In a further embodiment, the user interface may comprise: an user interface for computer network for use in a professional services practice, comprising: one or more distributed applications; case management database adapted to communicate with said one or more distributed applications; data storage cooperating with one or more case management databases; and the user interface cooperating with one or more of said data storage and said one or more distributed applications.

In yet another embodiment, the present invention may be an application for managing a professional services practice, comprising: one or more proprietary applications; data storage adapted to cooperate with said one or more applications for storing data relating to the professional services practice; shareware applications; said shareware application cooperating with one or more of said one or more applications and said data storage to render the data portable.

In another alternative embodiment, the invention comprises a data processing system for managing data relating to a professional services project and providing pertinent data to a user, comprising: a network; one or more proprietary, distributed applications; a server for distributing said one or more proprietary, distributed application means to the user on said network; data storage for storing said data, said data storage being adapted to cooperate with one or more of said server and said one or more distributed applications; first data integration, cooperating with one or more of said server, said one or more distributed applications, and said data storage, for transferring said data; storing said data in a format other than a substantially proprietary format; and providing said data to a user.

In yet another alternative embodiment, the invention includes a method for use in a data processing network for a professional services practice comprising one or more proprietary software applications, the method comprising: accessing a proprietary application; storing data used in conjunction with said proprietary application; case management, being in a format other than the format of the proprietary application, securing from the proprietary application on an automated basis, without human intervention, said stored data used in conjunction with said proprietary application; the case management means storing the data in a format other than the format of the proprietary application; accessing case management; accessing said data stored in said case management; making said data in format other than the proprietary format available to a user.

In additional alternative embodiments, the present invention may be embodied in a shareware application, or in further alternative embodiments, in a quality control system and financial reporting system for a professional services practice.

In certain embodiments, the system and method can be used for litigation cartography to generate litigation billing codes that can be used to form the basis for a legal services delivery measurement and analytics solution and, when linked to a specified activity, provide the opportunity for narrative-free billing and timekeeping. By creating “good data,” litigation cartography makes real the possibility of “moneyball” analytics for practitioners. In short, “good” data leads to actionable data, which in turn leads to data-driven decisions making and better risk management.

In certain embodiments, the system and method provides an architecture rooted in how litigation works in maximally efficient manner. When instant litigation taxonomy is deployed within a document management, eDiscovery, or case management software, the utility of the technical tool can be matched, for the first time, to workflows that litigators already use. Through the application of the instant system and method tools, in-house teams and law firms alike can better leverage the data they create and manage for planning purposes and for assessing the value of the litigation services being provided. The system and tools further make it easier for litigators even at different firms or companies to consolidate, share, and leverage their collective data.

In certain embodiments, the invention encompasses a system and method developed including a comprehensive, stages/parts/elements approach to train and teach litigation to lawyers, paralegals, and clients—or anyone else. Moreover, this tool can be used to bridge the gap between training (e.g., law school) and competency in a way that no other program can or has.

The system and method for litigation cartography was developed by using proven design methods and UI/UX designers to clarify and organize the litigation process and to complement existing litigation technologies. Borrowing from proven concepts founded in Information Design theory, this method works by first disaggregating the litigation process into discrete components and then mapping those components into 6 stages (e.g., Pleadings), 21 parts (e.g., The Plaintiff's Complaint), and 100 elements (e.g., Service of Process). This breakthrough methodology (1) makes litigation teachable and trackable at every procedural point—enabling it to be measured, analyzed, and billed with this standard of precision—and (2) provides the foundation for communication, both for professionals and their technology, upon which today's collaborative solutions can be built and to which existing tools can be aligned.

It is to be understood that both the foregoing general description and the following detailed description are exemplary and explanatory only, and are not restrictive of the invention as claimed. The accompanying drawings, which are incorporated herein by reference and constitute a part of the specification, and in which like numerals are used to refer to like elements, illustrate certain embodiments of the invention, and together with the detailed description, serve to explain the principles of the present invention.

### BRIEF DESCRIPTION OF THE DRAWINGS

FIG. 1 and FIG. 2 illustrate an exemplary organizing structure behind the system and method of the invention.

FIG. 3 illustrates a taxonomy of the system and methods for tracking data.

FIG. 4 illustrates an exemplary illustration of a types of analytic report that can be derived through the use the instant system and method.

FIG. 5 illustrates an exemplary illustration of a types of analytic report that can be derived through the use the instant system and method.

FIG. 6 illustrates an exemplary illustration of a types of analytic report that can be derived through the use the instant system and method.

FIG. 7 illustrates an exemplary illustration of a types of analytic report that can be derived through the use the instant system and method.

FIG. 8 illustrates an exemplary illustration of a types of analytic report that can be derived through the use the instant system and method.

FIG. 9 illustrates the unique supplement to the existing document management solutions to allow litigators to experience how the system and method can benefit their practices.

### DETAILED DESCRIPTION OF THE INVENTION

The systems and methods described herein comprise a processor-implemented multi-step analysis designed to start with broad observations, and arrive at the highest-priority strategic actionable insights in a repeatable, automated fashion.

The system and method of the invention can be utilized in various industries including, but not limited to, an accounting practice, law practice, medical practices, consulting services, and other professional services practices, as well as other business applications. The following detailed descriptions of various preferred embodiments, and examples of the invention, are illustrative and explanatory only and should not be construed to limit the present invention as disclosed and claimed.

Various programming and database development techniques are well-known in the art. Applicant expressly intends that these, as well as protocols, standards, and techniques yet to be developed, be considered within the scope of the present invention.

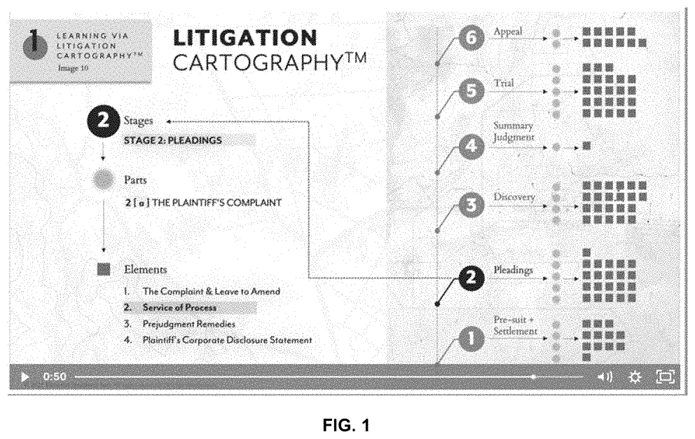

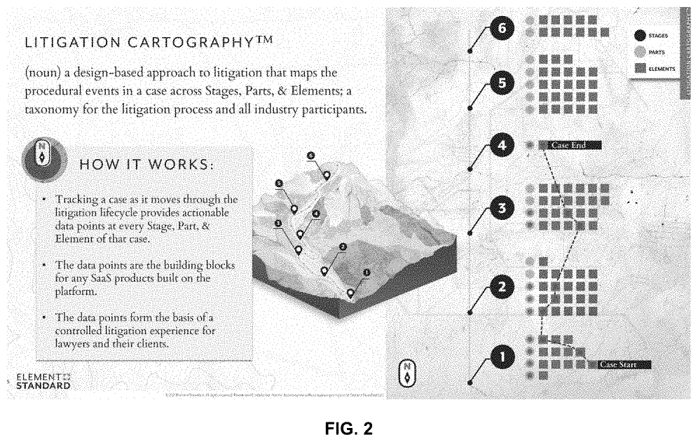

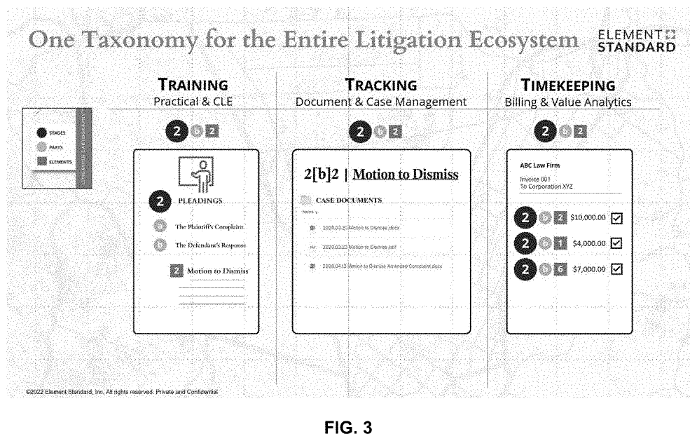

The basic organizing structure behind the Litigation Cartography method is illustrated in FIGS. 1 and 2. The Litigation Cartography method can be deployed in a variety of ways as illustrated in FIG. 3.

In certain embodiments, the systems and methods of the invention include a network hosting multiple distributed software applications used in the practice. These applications typically store the data used by the-applications in proprietary or substantially application-dependent formats.

In certain embodiments, time entries are typically key entered by secretarial staff and/or timekeepers. Expenses are also typically manually entered into a firm's cost recovery systems (photocopies, faxes, postage, and various ancillary services) or may be captured by automated cost recovery components. Other charges are posted to the firm's accounts payable system based on submission of documentation that has been authorized by the appropriate supervisor. These accounting data are then compiled and used to track the cost of the project, compare cost versus budgeted amounts, and prepare invoices to clients. In a law firm setting, these accounting records are typically maintained in a proprietary format.

In other embodiments, docket entries are typically key entered by a docketing clerk or department, based upon physical documentation received about events relating to a project Docketing may also be accomplished by scanning bar-coded or other documentation. Alternatively, data may be downloaded from the PTO, EPO, or other governmental website. Docketing is typically carried out in a proprietary system. These applications have been highly constrained with respect to the formatting of the data. In general, docketing data is not readily transferable from docketing systems to other applications, among docketing systems from different vendors, or between non-sequential and in some cases, even sequential versions of the same vendor's docketing system.

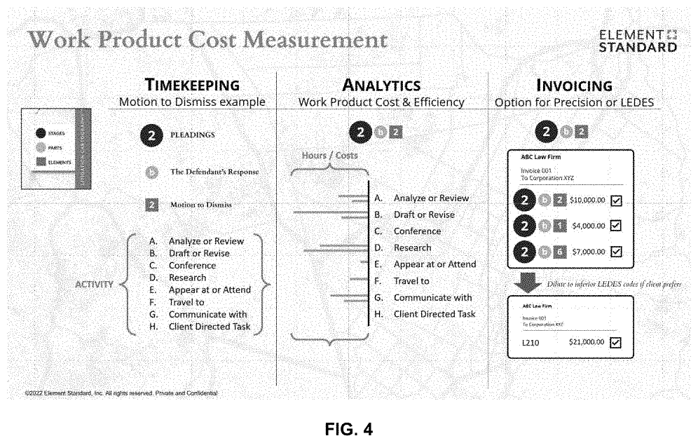

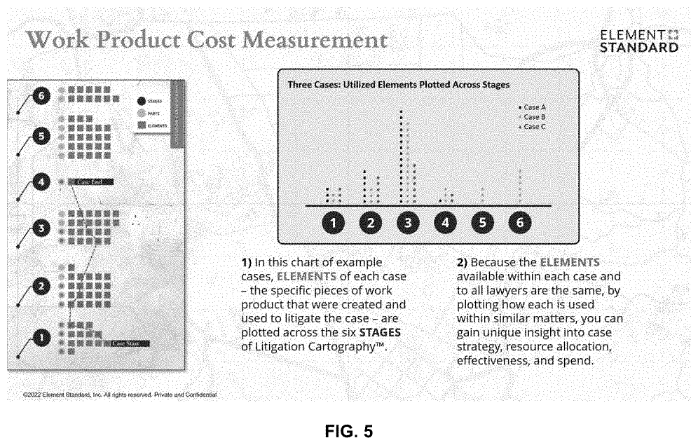

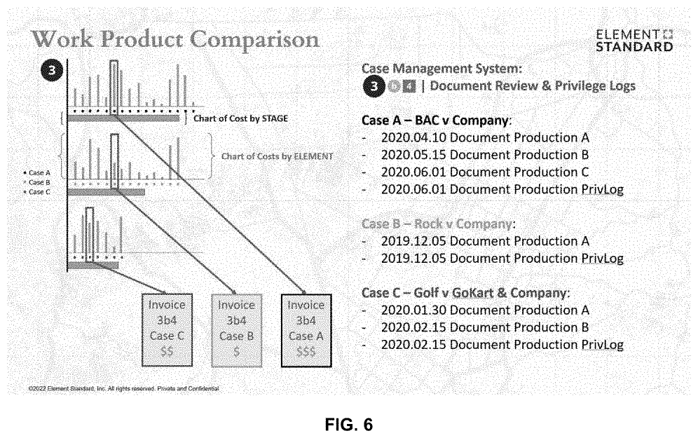

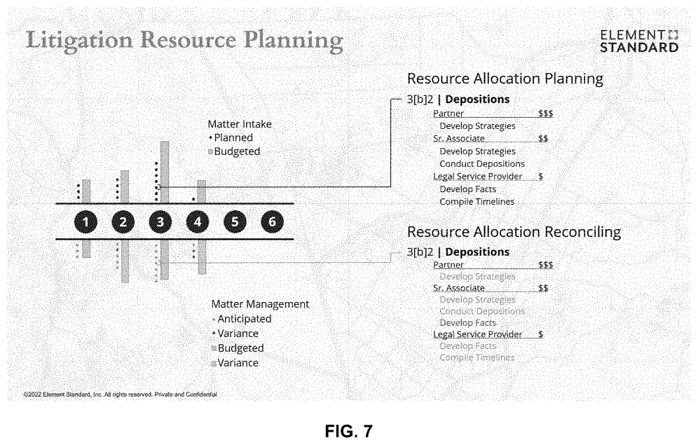

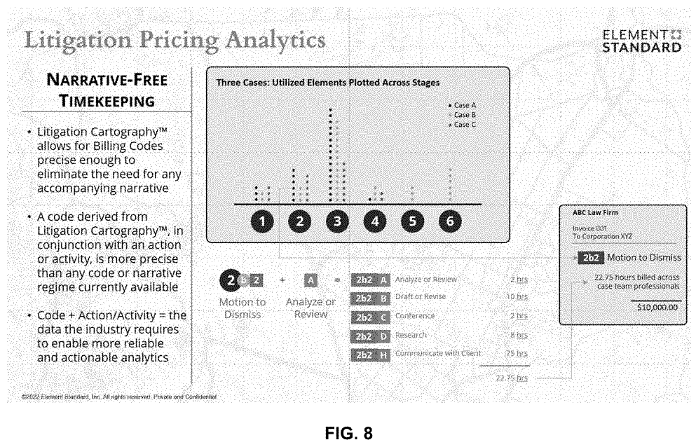

By using the data created through the application of the system and method for litigation cartography, decision makers can gain important insight into a particular matter or across matters or even across firms using various platforms. FIGS. 4-8 are examples of the types of analytics that can be derived through the use the instant system and method.

Document management systems maintained in a firm's word processing or docketing system or as a separate documents management system application typically use the same information. With multiple sources of information, however, it is often unclear which records are up to date and which are not valid. Depending on the network configuration, access to certain sources of the information may be slowed or impaired. Moreover, multiple sources for the same information invites errors in data entry, retrieval, and maintenance.

Firms generally employ a variety of resources to maintain knowledge bases of information. For example, legal documents and a wide variety of other materials typically are maintained in a firm's knowledge management and/or document management systems. Attorneys may subscribe to various services or reference forms and precedents over the web. Precedents may also be accessed as email attachments. In recent years, the market for support services has expanded substantially and now includes legal research services provided by third party vendors. These vendors may also supply data used by the firm, through electronic communications such as email.

It has become common practice to employ the firm's document management system to index work product precedent, in lieu of a separate knowledge management system. This approach, however, is heavily dependent on the quality of abstracting in the firm's document management system because full text searching through the entire document management system is often not practicable. Many of these document and knowledge management databases are maintained in a variety of inconsistent and/or incompatible formats, necessitating access to multiple software applications.

Firms also maintain records of communications, correspondence, legal and fact research, and official communications received in conjunction with a representation. These records may be maintained in electronic form.

Data Collection

In various embodiments, systems and methods of the disclosure include a data collection subsystem of processor executable instructions to periodically aggregate documents related to the business interests of current and potential clients (i.e., entities) via a communications network of one or more document monitoring portals. In order to achieve the objective of offering strategic advice for business decision-making, systems and methods of the disclosure cull and prioritize the full range of documents to form concise, informative business reports. Moreover, systems and methods of the disclosure use cues within the data to make predictions about upcoming and developing issues, and use recurring research updates to show issue changes and trends.

The input to the systems and methods described herein is any sizeable collection of text documents. This collection typically consists of documents from various sources, all targeted toward specific issues of interest. As noted herein, each document, upon retrieval, is annotated automatically using processing systems to identify document. These annotations, along with the full text, are stored in databases, and are available for each of the steps in the processor-implemented analysis of the systems and methods described herein.

Topic Modeling

The next step after data collection by subsystem in the systems and methods described herein is to classify by an initial topic modeling subsystem of processor executable instructions the multitude of text documents into binned topics of discussion, or issues. In one form, the systems and methods described herein automatically identify all topics, including new, emerging topics in a quick and efficient manner using any collection of documents a user provides so that training data is minimized or not required.

For example, the systems and methods described herein apply text analytics technology to discover the topical structures of documents and classifying those documents into different topical categories. Litigation cartography has several advantages over traditional classification techniques. First, no manually-classified training data is needed. Second, Litigation cartography is adaptive to topical change. These advantages can be achieved because Litigation cartography learns the topical categories from a set of documents directly; no knowledge (or limited knowledge) about the topical categories is required in advance. Third, in Litigation cartography, unlike in other techniques, a document can be assigned to specific topical categories.

In systems and methods described herein, each topic discovered during the Litigation cartography analytics represents a document within the targeted dataset stored in databases. Issues are given meaningful labels by an operator via an operator input device by a person with knowledge related to the overall dataset using the semantics of the set of terms with the highest topic-term probabilities for the given topic. As such, contextually off-target topics and issues identified during the labeling analytics are discarded by an operator via the operator input device; additionally, highly-overlapping issues are combined as deemed necessary.

Subtopic Modeling

In some cases, an issue derived from the Litigation cartography analytics may be useful in the identification of concise core messages or actionable key insights. After such issues are identified by an operator via the operator input device during the topic-labeling analytics, the text from the documents assigned to these issues is collected and re-run through the Litigation cartography analysis systematically by a server, issue-by-issue, in order to achieve more granular divisions of topics within these issues. After the more granular “subtopics” are labeled by an operator via the operator input device, off-target subtopics are discarded as before, while contextually relevant subtopics are promoted as independent issues, and added to the complete list of issues discovered during the Litigation cartography analytics. The topic modeling Litigation cartography may be accomplished by an initial topic modeling subsystem followed by a subtopic modeling subsystem of processor executable instructions. Alternatively, the initial topic modeling and the subtopic modeling may be accomplished by a single topic modeling subsystem and the subtopic modeling subsystem merely redirects topics to topic modeling subsystem for further granular analysis.

Thus, in one form, the topic modeling subsystem Litigation cartography includes the initial topic modeling subsystem and the subtopic modeling subsystem comprising processor executable instructions including initial topic modeling instructions for identifying one or more initial issues in the collection of the retrieved documents according to terms in the retrieved documents, and subtopic modeling instructions for identifying one or more issues in each of the initial issues of the retrieved documents according to terms in the retrieved documents for each initial issue.

Issue Assignment

As described above, the prominence of a topic within a document is defined by an issue assignment subsystem of processor executable instructions using the probabilities in a document-topic probability matrix. The systems and methods described herein move forward by using these probabilities to formally “assign” a discrete number of the most highly-prominent topics represented in each document to the document itself in the following manner:

Thus, in one form, the issue assignment subsystem of processor executable instructions comprises issue assignment instructions for limiting the number of issues formally associated with each of the retrieved documents based on the values in the document-topic probability matrix.

Predictive Issue Ranking

The next step in the analytics is executing a predictive issue ranking subsystem of processor executable instructions to rank-order the assigned issues identified in the topic modeling subsystem and subtopic modeling subsystem and assigned by the issue assignment subsystem. Top-ranked issues will be deemed to be the most significant issues in the current landscape of the business decision-making process.

Ranking is performed by combining several per-issue summary metrics into a single quantitative score for each issue. These per-issue quantitative scores may then be sorted numerically to determine the overall order of significance of the issues.

In various embodiments, the systems and methods may be provided to identify projected and actual budget performance for a project. Some of the tools that may be used in conjunction with the invention preferably include, without limitation: tables; schedules; spreadsheets; databases; graphs; indicia; icons; and any other means adapted to provide budget information for a project or matter. Budget of the present invention may take any format suitable for use in conjunction with the system for providing useful budgeting information. Budgets could be tracked separately by expenses and fees, as well as at various discrete stages of the project.

In the context of rendering legal services, various types of budgeting software are generally used. Some of these software systems include budget modules or budget functionality that may be adapted for use in conjunction with the invention. These prior systems, however, have been hampered by their inability effectively to deliver budgeting data and fee billing tracking to the user in a format in which it can readily be used or manipulated. It may be necessary, therefore, to export the data from these financial accounting software packages to other format(s) from which it can be used more effectively in management of the professional services practice.

Data may be exported in particular formats so that they can be read by or transferred to the system and method of the present invention. Alternatively, data may be exported directly to the system to the present invention or to an intermediate database.

Exemplary Method Applications

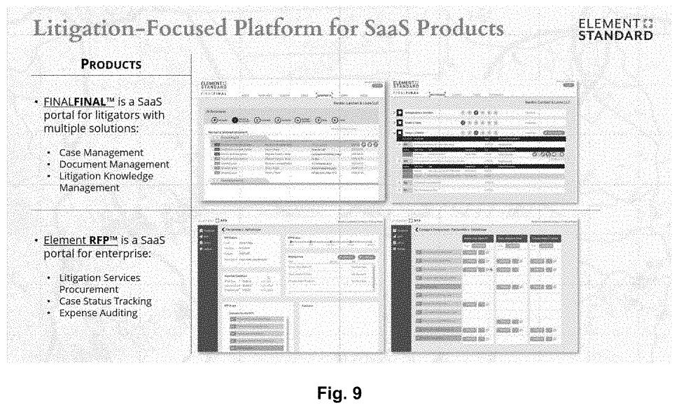

The system and method includes a document organizing system, a SaaS solution for users to store, retrieve, and share definitively final versions of their work product via the consistent storage structure provided by Litigation Cartography. As illustrated in FIG. 9, this unique supplement to existing document management solutions is the first opportunity for litigators to experience how Litigation Cartography can benefit their practices.

Similarly, the Litigation Cartography system and method lies at the heart of Element Standard's Exit Ramp Litigation approach, which identifies and explains specific opportunities and strategies premised on the Federal Rules of Civil Procedure for concluding litigation before trial. By using our Exit Ramp Litigation approach, users (e.g., attorneys and clients) can more readily assess “where they are” on the highway of litigation and develop tactics and strategies, as well as make better informed resource allocation decisions, regarding how to position a particular case for a desired outcome.

As can be seen, the unique approach and methodology make litigation more trackable at every level of the process and enables key decision makers and stakeholders to measure and analyze the content and value of litigation services at a more granular level and with more reliability and consistency. Moreover, because approach of the invention matches process to practice:

Better, more reliable data is generated, leading to higher confidence in decisions making and improved risk management.

The litigation process is more reliably learned, managed, and valued, allowing key stakeholders to make data-driven decisions and better leverage analytics to achieve efficiencies and capture insights into process and performance.

In the same way a yardstick allows a standard measurement in yard/feet/inches, litigation cartography provide the same ability to measure and benchmark litigation in standard units: stages/parts/elements of a case. The system and methods are thus highly scalable (to multiple cases, multiple teams, and/or multiple firms), useful for voluminous data sets, and easy to deploy.

What is claimed:

1. A system comprising: a communication network; a computing device in communication with the communication network, the computing device to receive electronic documents from electronic media sources via the communication network; the computing device having memory and a processor, the memory having processor executable instructions stored in the memory that when executed by the processor cause the processor to perform operations comprising:
retrieving and scoring documents from the electronic media sources via the network by processing on each document of the documents from the electronic media sources and storing full text and a single-valued score from each document in a database;
identifying at least one issue in each of the retrieved documents according to terms in the retrieved documents including: weighing each term in each of the retrieved documents with respect to relevance of the term to each identified issue;
indicating a distribution for identified issues within each of the retrieved documents; formally associating a list of specific issues with each retrieved document; ranking the issues relative to each other based on weighted summary metrics; and displaying on a display, the issues ranked in order relative to each other based on the weighted summary metrics.

2. The system of claim 1, the operations further comprising: identifying at least one initial issue in the collection of the retrieved documents according to terms in the retrieved documents; and identifying at least one issue in each of the at least one initial issue of the retrieved documents according to terms in the retrieved documents for each initial issue.

3. The system of claim 1, the operations further comprising determining a topic-term probability matrix and indicating the distribution for identified issues within each of the retrieved documents by determining a document-topic probability matrix.

4. The system of claim 3 the operations further comprising limiting the number of issues formally associated with each of the retrieved documents based on the values in the document-topic probability matrix.

5. A non-transitory computer readable storage medium having instructions stored thereon that, when executed by at least one processor cause the at least one processor to perform operations, the operations comprising:
retrieving and scoring documents from electronic media sources via a communication network by processing on each document of the documents from the electronic media sources and storing full text and a single-valued score from each document in a database;
identifying at least one issue in each of the retrieved documents according to terms in the retrieved documents including: weighing each term in each of the retrieved documents with respect to relevance of the term to each identified issue;
indicating a distribution for identified issues within each of the retrieved documents; formally associating a limited list of specific issues with each retrieved document;
ranking the issues relative to each other based on weighted summary metrics; and
displaying on a display, the issues ranked in order relative to each other based on the weighted summary metrics.

6. The medium of claim 5 the operations further comprising: identifying at least one initial issue in the collection of the retrieved documents according to terms in the retrieved documents; and identifying at least one issue in each of the at least one initial issue of the retrieved documents according to terms in the retrieved documents for each initial issue.

7. The medium of claim 6 the operations further comprising determining a topic-term probability matrix and indicating the distribution for identified issues within each of the retrieved documents comprises determining a document-topic probability matrix.

8. The medium of claim 7 the operations further comprising limiting the number of issues formally associated with each of the retrieved documents based on the values in the document-topic probability matrix.

9. A method comprising: retrieving and scoring documents from electronic media sources via a communication network by processing on each document of the documents from the electronic media sources and storing full text and a single-valued score from each document in a database;
identifying at least one issue in each of the retrieved documents according to terms in the retrieved documents including: weighing each term in each of the retrieved documents with respect to a relevance of the term to each identified issue;
indicating a distribution for identified issues within each of the retrieved documents;
ranking the issues relative to each other based on weighted summary metrics; and displaying on a display, the issues ranked in order relative to each other based on the weighted summary metrics.

10. The method of claim 9, further comprising: identifying at least one initial issue in the collection of the retrieved documents according to terms in the retrieved documents; and identifying at least one issue in each of the at least one initial issue of the retrieved documents according to terms in the retrieved documents for each initial issue.

11. The method of claim 10, further comprising determining a topic-term probability matrix, and indicating the distribution for identified issues within each of the retrieved documents comprises determining a document-topic probability matrix.

12. The method of claim 11, further comprising limiting the number of issues formally associated with each of the retrieved documents based on the values in the document-topic probability matrix.
